(19) United States
(12) Patent Application Publication
(10) Pub. No.: US 2009/0165578 A1
(43) Pub. Date: Jul. 2, 2009

(54) DISSOLUTION TEST EQUIPMENT AND METHODS FOR TESTING

(75) Inventors: Michael Zamloot, Hillsborough, CA (US); Cherng-chyi Fu, Saratoga, CA (US); De-Hwa Chao, Cupertino, CA (US); Andrei Blasko, San Bruno, CA (US)

Correspondence Address: K&L Gates LLP, P.O. Box 1135, CHICAGO, IL, 60690, US

(73) Assignee: PAIN THERAPEUTICS, INC., San Mateo, CA (US)

(21) Appl. No.: 12/329,369

(22) Filed: Dec. 5, 2008

Related U.S. Application Data
(60) Provisional application No. 61/012,034, filed on Dec. 6, 2007.

(51) Int. Cl. G01N 37/00

(52) U.S. Cl. 73/864.91

(57) ABSTRACT

Dissolution test equipment (e.g., apparatus) and methods for testing are disclosed. Such methods and equipment may be advantageously used for testing of drug or active pharmaceutical ingredient (API) preparations, including drug formulations and dosage forms.

### CROSS-REFERENCE TO RELATED APPLICATIONS

This application claims priority to U.S. Provisional Application No. 61/012,034, filed on Dec. 6, 2007, which is hereby incorporated by reference in its entirety.

### FIELD

Dissolution test equipment and methods for testing are provided. The equipment (e.g., apparatus) described herein relates generally to drugs, pharmaceutical compositions, and dosage forms. The methods for testing described herein generally relate to release of drugs and active pharmaceutical ingredients (APIs) from dosage forms. The equipment and methods are useful for testing drug dosage forms dependent on disintegration, dissolution or diffusion transport phenomena. The dosage forms are suitable for mammals, including for human and veterinary applications.

### BACKGROUND

In formulating drug dosage forms, it is desirable that dosage forms allow a variety of release profiles, including immediate, delayed, controlled or sustained release. For example, dosage forms may be prepared that allow for modified release of the drug active over a period of time, such as a number of hours, a day, a week, or longer. This long-lasting effect, allows administration of a drug only once per time period, rather than more frequently.

Many drugs are formulated to dissolve over a variety of periods of time. Such dosage forms may include a variety of excipients that are designed to dissolve, erode, or disintegrate over a desired period of time. The release also may be designed for a particular pH, for example, for dissolution in the stomach at a lower pH, or perhaps later in the intestines, at a higher pH. Some dosage forms may be designed for immediate or delayed release, including over a relatively shorter or longer period of time, such as tablet, capsules, suppositories or sublingual capsules.

Drug dosage forms may be formulated with a variety of excipients or matrix components that influence the release of the drug active from the matrix. These excipients may include hydrophilic polymers, hydrophobic polymers, surfactants, disintegrants, waxes or other components. Examples of disintegrants include corn starch, potato starch, carboxymethylcellulose, alginic acid, guar gum, and so forth. The drug or API itself may only be present in a small amount relative to the amount of other excipients in the formulation or dosage forms. The drug or API thus may be a small portion of the total mass of the dosage form. The drug or API is processed with and accompanied by one or more specific excipient or ingredients designed to distribute the drug active by one or more mechanisms and over a desired time period.

One problem that arises, as a drug formulation or dosage form is designed, is how to test for desired release. In vivo (e.g., human or animal) tests may be conducted, but these are expensive and are conducted with a low frequency at great expense, over long periods of time, in order to attend properly to all the requirements of supervisory agency regulations. Thus, it is common to use in vitro testing with carefully designed equipment in controlled settings to determine the release of a drug over time. These tests, typically designed for drug formulations or dosage forms that release the drug via a dissolution or disintegration method, can then be correlated with in vivo testing to arrive at commercial formulations.

For oral formulations or dosage forms, the rate at which the drugs or APIs are released and/or dissolve in gastrointestinal fluids is important in the design and use of orally administered formulations and dosage forms. The drug or API must be released or dissolved before it can be absorbed by the body. The rate at which the drug or API enters into solution is known in the art as the dissolution rate, and the determination of the dissolution rate in vitro is known as dissolution testing.

Dissolution testing provides a better understanding of the amount of a drug or API available at a particular absorption site at various times. In addition, establishing a relationship between dosage form and availability of a drug or API at certain absorption sites and systemic blood levels of such drug or API aids in the development of specialized delivery techniques.

The concept of using in vitro data to predict or model in vivo behavior, referred to as in vitro-in vivo correlation, or IVIVC, is of great interest in the pharmaceutical industry. In vitro test methods that measure the rate of drug release with good IVIVC are better for detecting problems with existing formulations and dosage forms and in the development of new formulations and dosage forms. Systems that correlate closely with the release, dissolution and absorption data obtained in vivo can be used in developing dosage forms as well as in the production, scale-up, determination of lot-to-lot variability, testing of new dosage strengths, testing or major or minor formulation changes, testing after changes in the site of manufacturing and for determining bioequivalence.

Problems may arise if a dosage form is designed not for disintegration, but for another mechanism, such as diffusional release from a matrix that does not disintegrate. For example, one of the US Pharmacopeia (USP) standard test devices used for dissolution testing as described in USP <711> is commonly known as a USP type II apparatus. USP Performance Test, General Chapter <711>, Dissolution, 2007 version. A USP type II apparatus uses a dissolving medium and a rotating paddle within a glass vessel to test for dissolution or disintegration of a drug formulation or dosage form. Samples are taken periodically to determine the concentration of drug within the medium. Test samples of a dosage form may be weighted by a short length of stainless steel wire and placed within the vessel. The sample generally sinks to the bottom of the vessel, below the paddle and the paddle shaft. As the paddle turns, typically from 50 to 200 rpm, most of the medium is stirred. However, the region directly under the paddle is quiescent, compared to other areas within the vessel. This area does not receive the agitation and turbulence experienced within the rest of the vessel.

Some samples that depend on dissolution or disintegration may thus not receive sufficient flow velocity to achieve the desired effect. Other samples, depending on a diffusion mechanism, may also not experience the desired rate of release. In addition to low flow velocity, if the sample rests on the bottom, the bottom of the sample itself may be occluded and thus not be exposed to the stirred medium that will cause dissolution, disintegration, or diffusion. What is needed is a better way to test in vitro for release of a drug or an active pharmaceutical ingredient from a drug formulation or dosage form.

### SUMMARY

Dissolution test equipment and methods for testing are provided. Such test equipment includes a modified type II dissolution apparatus and such methods include novel media useful in the methods and with the equipment.

One embodiment is an apparatus for testing release from a drug sample. The drug sample used as a test sample may be a pharmaceutical preparation in any suitable form for testing (e.g., a drug or API formulation or dosage form). The apparatus includes a generally cylindrical vessel, optionally having a lower portion of the vessel in a shape of a hemisphere, a shaft and a paddle connected to the shaft suspended within the vessel, the shaft centered on the vessel, and a sample holder mounted to or suspended within the vessel and a basket mounted to the sample holder, the basket suitable for holding a drug sample for testing, wherein a volume of the basket is adjustable, and wherein the vessel is configured for circulating a medium within the vessel and around the drug sample.

Another embodiment is an apparatus for testing release from a drug sample. The apparatus includes a generally cylindrical vessel optionally having a lower portion of the vessel in a shape of a hemisphere, a shaft and a paddle connected to the shaft suspended within the vessel, the shaft centered on the vessel, and a sample holder mounted to the vessel or suspended within the vessel and a mesh basket mounted to the sample holder, the basket suitable for holding a drug sample for testing, the mesh basket configured with mesh surrounding the sides of the sample.

Another embodiment is a method for testing release of a drug or an active pharmaceutical ingredient from a sample. The method includes steps of providing a drug sample, suspending the drug sample in a mesh basket within a testing vessel, the testing vessel having a generally cylindrical shape and optionally a bottom in a shape of a hemisphere, and the mesh basket configured with mesh surrounding the sides of the sample, placing a medium within the vessel, rotating a paddle within the medium and around the sample, and testing the drug sample for release of the drug or active pharmaceutical ingredient by periodically sampling the medium within the testing vessel.

Another embodiment is a method for testing release of a drug or active pharmaceutical ingredient from a sample. The method includes steps of providing a drug sample, wherein the drug sample releases an drug or active pharmaceutical ingredient from the drug sample, suspending the drug sample in a mesh basket within a testing vessel, the testing vessel having a generally cylindrical shape and optionally a bottom in a shape of a hemisphere, wherein a volume of the mesh basket is adjustable and is configured with mesh surrounding the sides of the drug sample, placing a medium within the vessel, rotating a shaft and a paddle within the medium and around the sample, and testing the drug sample for release of the drug or active pharmaceutical ingredient by periodically sampling the medium within the testing vessel.

Another embodiment is a method for testing release of a drug or active pharmaceutical ingredient from a sample. The method includes a step of suspending the test sample on a paddle within a testing vessel, the testing vessel having a generally cylindrical shape and optionally a bottom in a shape of a hemisphere, wherein a volume of the mesh basket is adjustable and is configured with mesh surrounding sides of the test sample. The method also includes steps of placing a medium within the vessel, rotating a shaft and the paddle within the medium, and testing for release of the drug from the test sample.

Additional features and advantages are described herein, and will be apparent from, the following Detailed Description and the Figures.

### BRIEF DESCRIPTION OF THE FIGURES

FIG. 1 is a perspective view of an apparatus for operating and controlling a plurality of release testing vessels;

FIG. 2 is an exploded view of a first embodiment of a release testing vessel;

FIGS. 3-4 are embodiments of baskets for use with a release testing vessel;

FIG. 5 depicts embodiments of baskets used with a sample-holding clip;

FIG. 6 is an exploded view of an embodiment of a test assembly for use with a basket;

FIG. 7A is an elevational view of a test vessel;

FIGS. 7B-7C are embodiments with baskets at an angled orientation;

FIG. 8 depicts an additional embodiment for holding a basket at an angle to a vertical and horizontal plane;

FIG. 9 depicts additional basket embodiments;

FIG. 10 is a flowchart for a first method of conducting release testing; and

FIG. 11 is a second flowchart for a method of conducting release testing.

### DETAILED DESCRIPTION

Release testing as conducted with USP type II dissolution testers is intended for dosage forms of pharmaceuticals that dissolve or erode in order to release the drug or active pharmaceutical ingredient within the dosage form. These testers are available from a variety of commercial sources, such as, for example, Varian Inc., Palo Alto, Calif., U.S.A., and its subsidiary Varian, Inc. Dissolution Systems, Cary, N.C., U.S.A, and Distek Corp., North Brunswick, N.J., U.S.A.

Type II dissolution testers may use a sample that is positioned at the bottom of the testing vessel. Even with a reasonable rate of rotation on the agitator or paddle, such as, for example, 50 to 200 rpm, the region at the bottom of the vessel that is directly under the paddle is quiescent and receives little fluid flow. Testing under these conditions may suffice for dosage forms that are intended to easily dissolve or erode. For some controlled-release dosages, portions that erode away may have a hydrophobic coating that prevents their dissolution and bioavailability. However, for dosage forms dependent upon diffusion for drug release, the dosage forms (e.g., tablet or capsule) may not dissolve or erode readily, and the particular form of the test described above may not be suitable. For example, a dissolution or in vitro test under these circumstances may not correlate to the bioavailability or in vivo performance of a dosage form whose delivery of a drug or active pharmaceutical ingredient occurs by diffusion.

Diffusion mechanisms differ from dissolving, eroding or disintegrating mechanisms in several ways. One difference may be that the matrix in a diffusion-controlled dosage form does not dissolve, erode or disintegrate to the extent of a matrix in a dosage form that delivers its drug or active pharmaceutical ingredient via a dissolution mechanism. Diffusion processes typically follow Fick's law, in that the flux or flow of a species depends on a concentration gradient and a proportionality constant. For diffusion, the proportionality constant is the diffusion coefficient of the species of interest in a particular matrix. In diffusion processes, the release of a species from a surface is thus dependent on a concentration gradient across the surface and the diffusion rate of the species from the capsule or other dosage form. The actual diffusion rate of a drug or active pharmaceutical ingredient from a dosage form depends on at least two rates, the rate of transport of drug molecules from the interior of the dosage form to the surface and the rate of release of drug molecules from the surface into the surrounding medium. Diffusion is thus seen to be a surface phenomenon, with the diffusion rate partly dependent on the available surface area. Diffusivities or diffusion coefficients for solids typically have dimensions of length squared per unit time, such as cm²/sec, emphasizing the dependence on surface area available for diffusion.

Release processes can include diffusion or osmosis. Drugs that use a diffusion mechanism for their delivery upon administration may include many dosage forms. For example, a drug may be administered as an injectable depot, an implant, an oral dosage form such as a tablet or capsule, a sublingual capsule, a transdermal patch, a suppository, or one of many topical forms, such as a cream or a gel. Forms such as an injectable depot or an implant may be placed intramuscularly, rather than subcutaneously, in order to achieve a time-release or controlled release activation performance. Many of these forms would benefit from testing in an apparatus that is designed for release of the active by a diffusion mechanism, e.g., a mechanism in which the matrix remains largely intact.

The transport method discussed above is hypothesized to apply also to drugs or active pharmaceutical ingredients which use primarily an osmotic delivery mechanism. Without being bound to any particular theory, it is believed that an osmotic mechanism functions in the manner described herein. For example, a capsule dosage form may contain a controlled-release drug formulation of a water-permeable, insoluble matrix and soluble drug and excipient ingredients which create an osmotic pressure. In the aqueous environment of the gastrointestinal (GI) tract, a hard gel capsule can dissolve, exposing the controlled release formulation to the aqueous gastrointestinal milieu. Water can then permeate the membrane surface or matrix of the controlled release formulation, the rate and extent which are influenced by the characteristics of the matrix. The matrix components including drug and excipients dissolve within the water that permeates the controlled release matrix creating an osmotic pressure within. The solubility and osmolality of the soluble ingredients (e.g., the drug and excipients), determine the osmotic pressure. The osmotic pressure within the semi-permeable, insoluble matrix is greater than the pressure in the surrounding environment thereby creating the driving force which controls the rate of drug delivery, thus delivering the drug from the matrix. Since the formulation is primarily a semipermeable, insoluble matrix, drug delivery is slow, and is controllable by varying the composition and the hydrophobicity and permeability of the matrix, and the concentration of the drug and excipients. The biologically inert components of the insoluble matrix remain intact during the GI transit and are eliminated along with a residual amount of the soluble components.

The rate of drug release resulting from diffusion can depend on the concentration difference of soluble drug between the inside and the outside of the matrix, the diffusivity or diffusion constant for the insoluble matrix formulation, and on the surface area available for diffusion. Similarly, the rate of drug release from osmosis can depend upon the concentration of soluble drug and ingredients, the osmotic pressure, the surface area of the dosage form, and the distance through which the drug molecule must travel to pass from the insoluble matrix to the surrounding gastrointestinal environment. Accordingly, the permeability of the fluid through the semipermeable, controlled-release matrix is important. When the drug formulation or dosage form is administered to a subject (e.g., a patient), these fluids are the appropriate body fluids, such as those in the stomach or gastrointestinal tract, the small intestine, the mucous membranes of the small intestine or the mouth, and so forth. In laboratory testing, an aqueous liquid medium is used to simulate body fluids, the medium moved past the diffusional surface or test sample by an agitator or paddle at a defined rotational speed and at a specified temperature, normally 37° C., body temperature (e.g., 37° C.).

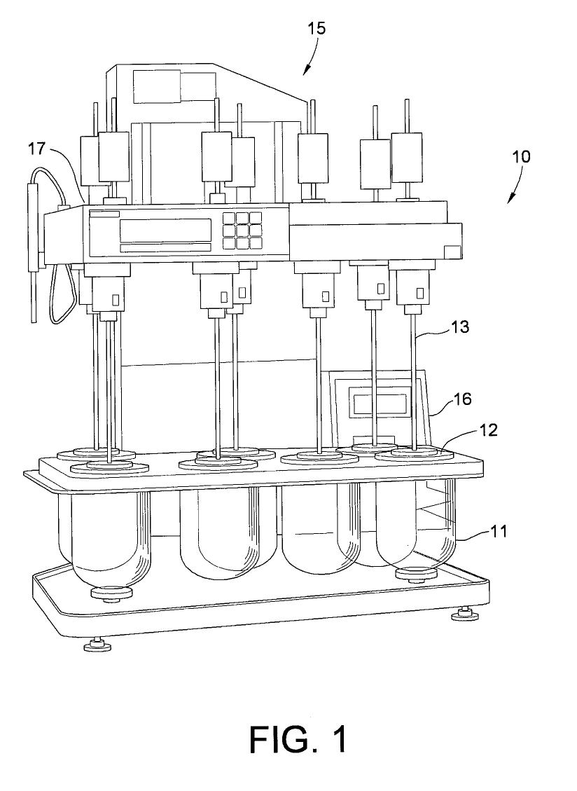

A testing apparatus for testing the rate of drug release resulting from diffusion is depicted in FIG. 1. A multi-vessel testing apparatus 10 includes, in this embodiment, seven glass vessels 11, each with a fitted cover 12 and a shaft 13 for rotating a stirring paddle, not visible in the Figure. This apparatus includes controls 15, 16 for accomplishing several functions, including monitoring the performance of the various parts, keeping the temperature in each vessel constant, rotating the shaft at a constant speed, periodically sampling the medium in each vessel, and so forth. Drive unit 17 includes chucks for mounting and rotating the shafts and paddles. The drive unit is raised for test set up and is lowered into place for testing. The drive unit is typically able to rotate the paddles and shafts with no more than about 2 mm (0.080 inches) runout during testing, i.e., the central axis of the shaft is within 2 mm of a central vertical axis of the vessel during testing. Testers that are commercially available, as noted above, are the starting point for the novel equipment, including modified apparatus, disclosed herein. The glass used for the vessels is inert with respect to the medium in the vessel, and is also inert with respect to a drug and its ingredients. Borosilicate glass and other high purity, high quality, non-reactive glasses are typically used. Stainless steel vessels could also be used, as could inert plastic vessels. Vessels 11 are typically contained within a constant temperature bath maintained at a constant 37° C. temperature. Other temperatures may also be used.

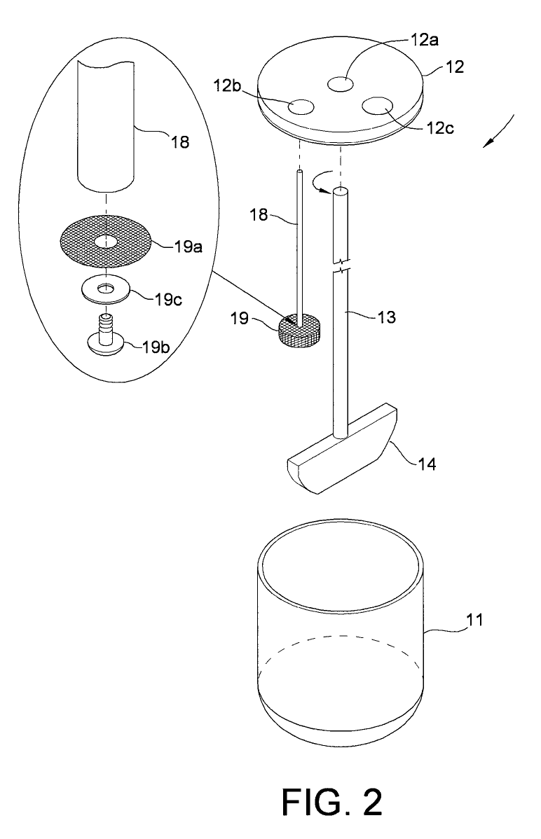

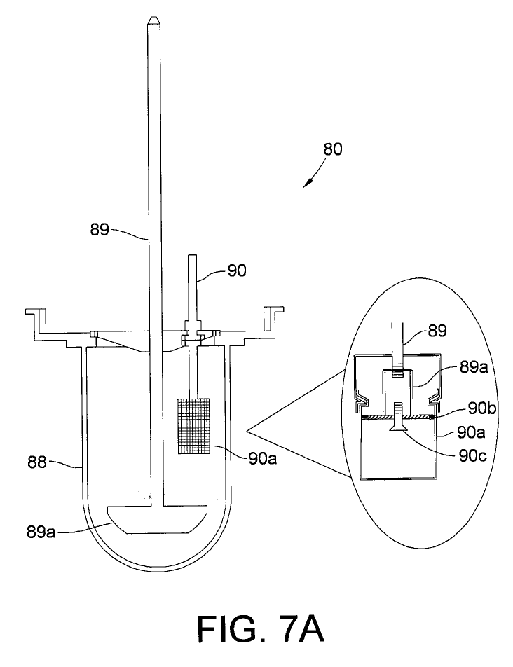

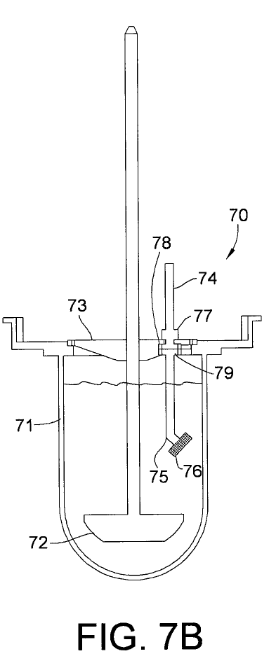

FIG. 2 discloses a first embodiment of a testing vessel. Vessel 11 is a one-liter vessel in the general shape of a right cylinder with a hemispherical bottom. Fitted cover 12 covers and closes the vessel to prevent contamination and to help maintain a constant temperature in the vessel. As also shown in FIGS. 7A and 7B, the under side of cover 12 has a roughly conical shape. Fitted cover 12 has three penetrations, a central penetration 12a for the paddle-stirring shaft, an orifice 12b for a sample-holding shaft and basket assembly, and a third penetration 12c for access to the vessel. The vessel is stirred by paddle stirrer 14 which is affixed to shaft 13 and rotated by a motor or other mechanism in the test apparatus 10. A sample holder 18 includes a mesh basket 19. In one embodiment, the sample holder 18 has internal threads as shown, for mounting the basket by a top portion 19a of the basket, a washer 19c and a small bolt or screw 19b. Baskets may be purchased from Varian Inc. (part number 12-2060) and modified as shown herein. The use of a mesh basket with a mesh top allows flow of testing medium throughout the basket (e.g., through virtually all surfaces of the basket) and around the sample (e.g., virtually all surfaces of the sample) within the basket. The baskets typically use stainless steel mesh, but they may be made of any medically acceptable material that will not react with the medium in the vessel. These materials should be non-absorptive and non-reactive with the medium or the drug product, and they should not interfere with the testing process. Such materials may include nylon, acetal, and polycarbonate, among others. These materials may be used singly or in combination, and should be easily sanitized to avoid cross contamination between uses. Parts may be coated with suitable inert coatings.

The radial position of the sample holder shaft 18 and basket 19 will be limited within the vessel by the position of cover orifice 12b, but the position of the basket may be adjusted vertically. The radial position may be changed by changing the radial position of orifice 12b. In one embodiment, covers are purchased from Varian, Inc. (part number 12-0469) and modified as shown herein. The three orifices are arranged as shown in FIG. 2 in the form of a right angle, with the central penetration 12a for the paddle shaft at the apex of the angle. In one embodiment, the distance from the center of the paddle shaft to the center of the basket is 2.781 cm (1.095 inches). Alternatively, the radial position of the basket may be changed by adding an arm or other device at an angle to the shaft, and then attaching the basket to the arm, as shown below. Screens with 20 mesh have performed well. Screens may be made from other mesh sizes, e.g., from 10 mesh to about 40 mesh. Other mesh sizes may also be used to retain the sample, but the size should be small enough to prevent the sample from exiting the basket. Basket 19 has a shape that may be described as a flat cylinder. Other basket shapes may also be used, such as rigid right cylinder, or a rectangular or square basket. In addition, other basket forms may be used, such as a basket that has the general shape of the dosage form. For example, a dosage form in the shape of a bullet (e.g., suppository), a capsule, or an oval may be placed in a basket in the shape of the dosage form. The basket may be made of mesh, and the mesh may comprise one or more wires.

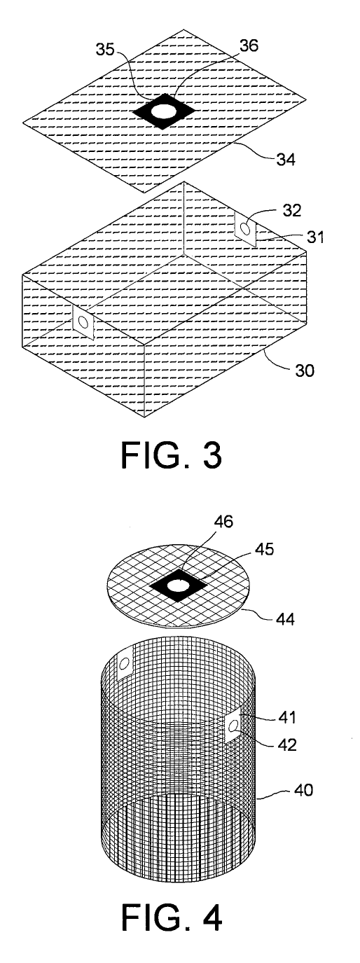

Additional mesh baskets are disclosed in FIGS. 3-4. A rectangular mesh basket 30 in FIG. 3 includes two tabs 31 with orifices 32 for attachment to the sample holding shaft. The basket top 34 also has a solid tab 35 with an orifice 36 for attachment to the sample holding shaft. In one embodiment, the basket top is made from 20×20 mesh, 0.018″ (0.457 mm) diameter 316 stainless steal wire cloth. It may be purchased from McMaster Carr, Los Angeles, Calif. (part number 9319 T558). In one embodiment, the basket tabs 31 are joined to lugs on the shaft while the top tab 35 is attached to the shaft itself, or to a standoff, discussed below. This allows vertical movement of the top 34 with respect to the basket 31. The volume of the basket is adjustable at least by adjusting the length of the standoff. In FIG. 4, a cylindrical basket 40, also made of mesh, has tabs 41 with orifices 42 for attachment to the lugs, and basket top 44 has a tab 45 and an orifice 46, for attachment to the shaft or standoff. The volume of basket 41 is thus also adjustable by adjusting the position of top 44 within the basket 40. The mesh for basket top 44 may be the same as the mesh used for the basket 40, or it may be different. For example, using a larger mesh for the basket top 44 may reduce frictional losses as the testing medium flows through the basket, e.g., the bigger mesh may help to increase hydrodynamics by minimizing interference with medium flow created by the paddle.

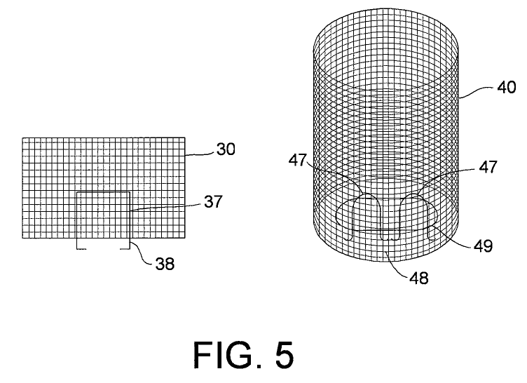

FIG. 5 depicts the baskets of FIGS. 3-4 with sample-holding clips that may be used to secure a test sample in place within the basket. As noted above, the volume of the baskets described herein are typically adjustable, by adjusting the position of the top within the basket. This helps to hold the sample in place by securing the sample between the top and bottom of the basket. The sample may also be held in place by securing clips as shown in FIG. 5. Securing clip 37 is a stainless steel spring that is formed so that its width will securely accommodate the test sample. Clip 37 includes inward-oriented feet 38 securing the clip to the mesh of basket 30. Two clips 47 secure test sample 49 to the mesh of basket 40. Clip 47 has outward-oriented feet 48 and is also made from stainless steel. Stainless steel is readily available, is non-absorptive and is non-reactive with the medium or the drug product, and does not interfere with the testing process. Other suitable materials may also be used.

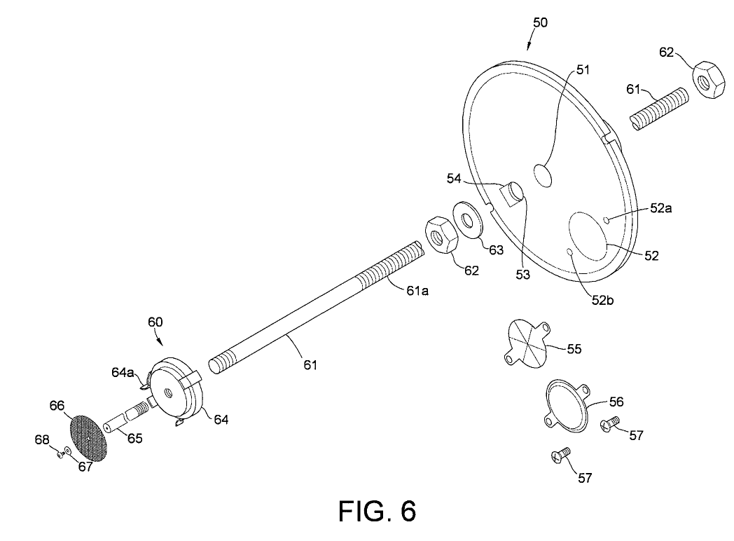

FIG. 6 is an exploded view of a vessel top 50 with a basket shaft 60 for use with a testing vessel. The figure depicts a basket shaft used to suspend the basket within the testing vessel. The basket shaft 60 includes a shaft 61 and securing nuts 62 for use on either side of vessel top 50. In one embodiment, shaft 61 is about 4 13/16″ long (about 123 mm). The top is made of a heat-resistant plastic or metal suitable for continuous use at 37° C. for days at a time. Top 50 includes a central orifice 51 for the paddle shaft and a testing orifice 52 to allow samples to be withdrawn periodically during testing. Orifice 53 with countersunk portion 54 on the bottom side creates a space for the securing nuts, as explained below. Sealing diaphragm 55 is secured to top 50 with fasteners 57 and sealing cover 56. The sealing diaphragm is made from relatively soft rubber or plastic, such as, neoprene, silicone or Viton. The sealing cover is made from relatively inert plastic.

The middle portion of shaft 61 is sufficiently threaded so that a first nut 62 bottoms out on the threaded portion. The gasket 63 is then placed onto the shaft 61 adjacent nut 62, and placed through the bottom-side or orifice 53 and secured snugly in place with another nut 62 on the top side of vessel top 50. The gasket helps to seal orifice 53. The length of the shaft and of the threaded portion determine the height of the sample basket as it is suspended within the vessel as first nut 62 resides within countersink 54. The basket is thus placed in the same fixed position within the vessel during repeated test runs. This helps to achieve uniform hydrodynamics and minimizes test variations from basket position. At one end of shaft 61 is a collar 64 and lugs 64a. The lugs are spring-mounts intended for securing a basket, as discussed above for baskets 30, 40. Alternatively, the lugs may include orifices to match the orifices of the tabs on the baskets shown above, using fasteners, such as screws, to secure a basket to the lugs and the basket shaft. A shaft standoff 65 screws into collar 64 or second portion 63. In one embodiment, standoff 65 is about 0.60″ (about 15 mm) long. Standoff 65 is intended for attachment to mesh basket top 66 using a washer 67 and a screw or bolt 68. The washer may be used with basket tops not having a tab, as explained in the discussion for FIGS. 3-4 above. In one embodiment, the top of the test basket is suspended about 7 cm (about 2.75 inches) below the top of the vessel cover, and is located about midway between the paddle shaft and the inner diameter of the vessel.

For testing purposes, it is desirable to be able to orient the basket, and thus the sample, with respect to the horizontal and vertical axes or planes of the testing vessel. Certain orientations, such as a particular angle to a vertical axis, may yield better correlations. Thus, the lugs on the collar may be used with the tabs on a basket to orient the basket. For example, the collar and lugs 64a in FIG. 6 may be used with the FIG. 3 basket 30 and tabs 31 to orient basket 30 at any desired angle in a horizontal plane within the testing vessel by turning shaft 61 or collar 64 to the desired angle. Baskets of other shapes may also be used, and baskets may also be designed for orientation with respect to a vertical axis or plane.

The testing apparatus 80 of FIG. 7A is shown in an elevational view. FIG. 7A shows qualitatively the relationships between the test components when assembled. In this embodiment, stirring shaft 89 and paddle 89a are centered within a standard 1 liter glass testing vessel 88. The basket-holding shaft 90 holds basket 90a about midway between the paddle shaft and the inner diameter of the vessel. The bottom of the paddle is about 1 inch (about 25 mm) above the bottom of the vessel. The detailed view depicts the component of mesh basket 90a, which includes a basket top 90b. The basket top is secured to shaft 89 with a collar and lugs and via standoff 89a using fastener 90c. The testing vessel typically has an inner diameter from about 100 to 104 mm (about 3.94 to 4.09 inches) and the paddle typically is about 74-75 mm (about 2.91 to 2.95 inches) wide.

The testing apparatus of FIG. 7B depicts another way to orient the basket and the test sample. Testing apparatus 70 includes a testing vessel 71, a unitary paddle and stirring shaft 72, and a sealing top cover 73 as discussed above. The sample-holding shaft 74 has a distal portion 75 formed at a 45-degree angle to both vertical and horizontal planes passing through shaft 74. Mesh basket 76 is attached at that angle to distal portion 75. Shaft 74 is secured to top cover 73 with an upper nut 77 threaded onto the shaft and with a lower nut 79 also threaded onto the shaft. Washer 78 helps to seal the orifice through which the shaft passes. Lower nut 79 and washer 78 fit within a countersink on the lower surface of the top cover.

There are other apparatuses to orient a basket, and the testing sample, in a desired orientation, as shown in FIG. 7C. Sample holder 20 includes threaded sample holding shaft 21 and an elbow 22. The elbow may be made at any desired angle, such as the 60-degree angle shown. The elbow allows the orientation of mesh basket 29 at a desired orientation to the vertical and horizontal. Adapter 23 joins elbow 22 to mounting collar 24, and threaded standoff 25 then mounts basket top 26 to the collar with a washer 27 and fastener 28. The standoff 25 determines the position of the basket top 26 within basket 29, which is secured to the collar with the lugs as shown. Basket 29 retains its rigidity with a heavier rim as shown.

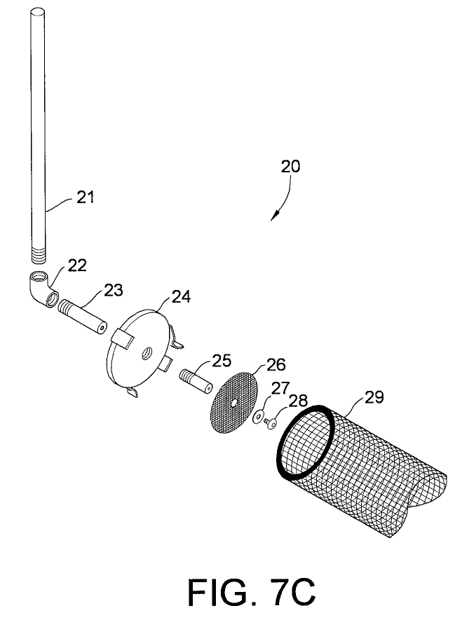

There are additional embodiments that allow for the desired orientation of the sample basket, and thus the sample. FIG. 8 depicts an example of a basket with orienting slots that align with matching tabs in the basket-holding lugs. The sample-holding shaft 81 includes a collar 82 and retaining-spring lugs 83 with tabs 84 at their distal ends. Tabs 84, in this example, are oriented at about a thirty-degree angle to the vertical axis of lugs 83 and shaft 81. This allows basket 85 with reinforced portion 86 and grooves 87 to fit between the lugs 83 at that angle, about thirty degrees. Other angles may be used. By using a longitudinal, angled groove, rather than a hemispherical tab, the basket will retain the desired orientation during the test and during repeated testing. The reinforced portion 86 may be a strip of stainless steel or other suitable material. The reinforced portion may be made from the same material as the basket mesh or it may be a different material, so long as neither material will affect the testing.

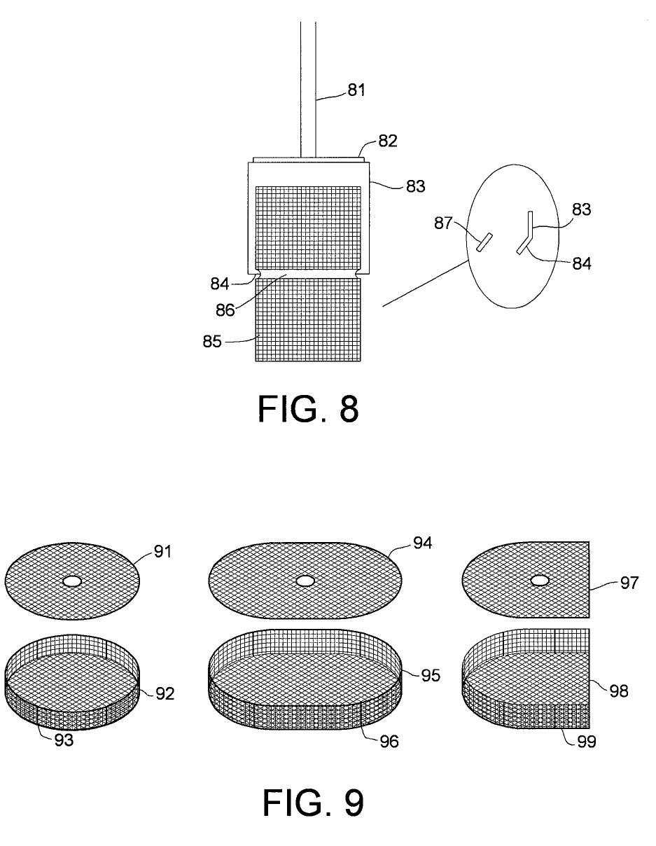

Additional basket embodiments may also be used for tighter control of the specific environment to which each test sample is exposed. The mesh baskets of FIG. 9 include basket that are made in the shapes respectively, of an oval 92, a capsule 95, and a bullet 98, each basket intended for use with a dosage form in that shape. The baskets include a reinforced vertical or transverse portions 93, 96, 99, shown as heavier lines on the tops, bottoms and sides of the baskets, and made of strips or bands of reinforcing material, to help retain the shape of the basket through many testing procedures. The baskets also include covers 91, 94, 97 with mounting orifices as discussed above. Any of these, or other embodiments with other reinforcements, may be used as shown in FIG. 8, to orient the basket during testing.

These devices have been used successfully for a variety of tests of capsules that are believed to be diffusion-limited. For example, such capsules include those that do not dissolve, erode, or disintegrate, but disperse the drug while the matrix remains more or less in its initial shape. A number of tests have shown these results, including recent tests with a matrix believed to be largely hydrophobic. These tests also show that dispersal of the drug is aided by use of a surfactant in the dispersal medium in the vessel. One typical medium is 0.1 N HCl. The solutions may be prepared by degassing USP purified water and filtering the water with a 2 μm filter. Other techniques may be used to prepare or obtain the water medium. Other media may also be used, such as phosphate buffered solution (PBS), for example, at pH 6.8 or acetate buffered solution, for example, at pH 4.5.

In order to achieve more thorough medium permeation during testing, novel media were prepared using a number of surfactants and solvents, in ranges from zero to about 2 percent by weight. For example, media were prepared with surfactants including Tween 80, Triton X-100, or sodium dodecyl sulfate (SDS), and solvents including propylene glycol or polyethylene glycol (PEG). Bile salts, such as cholate and deoxycholate, may also be used as surfactants. Bile salts are believed to have detergent properties because they are used to aid digestion. For example, they have detergent properties that are used to emulsify lipids in foodstuffs passing through the intestine, enabling digestion and absorption through the intestinal wall. Of course, it is difficult to retain in the vessel solvents or surfactants having a low boiling point, such as ethanol (boiling point 78° C.).

Some of the experimental work was done with an oral drug dosage form having a relatively soluble hard gelatin capsule exterior with a water insoluble modified release formulation matrix. The matrix was non-water soluble and had a diffusion-controlled drug-delivery mechanism. Ingredients included a non-polymeric highly viscous fluid, a hydrophobic solvent, a hydrophilic solvent, and a polymer additive. Additional ingredients included an antioxidant and other ingredients suitable for pharmaceutical preparations. In vivo testing of the dosage form revealed that about 80-95% of the drug was released and absorbed 24 hours after ingestion. In vitro release tests of the dosage forms, using standard USP type II dissolution testers and standard test methods, showed that standard 0.1 N HCl solutions did not similarly extract the drug from the drug matrix (e.g., about 20% to about 60%). In contrast, the use of surfactants, combined with a novel modified USP type II apparatus as described herein, and a higher paddle speed, resulted in extraction of about 80-95% of the drug. Tables 1-5 with exemplary results are shown below.

TABLE 1
% Cumulative Drug Release

| | 3 hr | 6 hr | 12 hr | 18 hr | 24 hr |
|---|---|---|---|---|---|
| Standard USP Type | 16 | 39 | 68 | 84 | 93 |
| II | | | | | |
| Modified USP Type | 38 | 63 | 90 | 102 | 106 |
| II with Stationary | | | | | |
| Basket | | | | | |

1. 40 mg capsule dosage form with 40 mg (5.13%) (non-micronized) Oxycodone; 319.6 mg (40.98%) Pharmaceutical sucrose acetate isobutyrate (SAIB); 213.1 mg (27.32%) Triacetin, USP; 111.0 mg (14.23%) Isopropyl Myristate, NF; 37.0 mg (4.74%), cellulose acetate butyrate (CAB) CAB 381-20BP; 44.4 mg (5.69%) Hydroxyethyl Cellulose; 14.8 mg (1.90%) Colloidal Silicon Dioxide; and 0.16 mg (0.02%) Butylated Hydroxytoluene. Other dosage forms with opioids other than oxycodone as a base as in this Table 1 or as a salt including, for example, oxymorphone, hydrocodone or hydromorphone, where the opioids are non-micronized or micronized, may be prepared and tested as in this Table 1 or additional tables herein with similar or identical % of drug or API and excipients (e.g., % w/w) as listed above for a 40 mg capsule dosage form, for example, when 5 mg, 10 mg, 20 mg or 30 mg of opioid is alternatively used in the dosage form. For a 60 mg or 80 mg capsule dosage form, the following alternative % w/w may be prepared and tested as in this Table 1 or additional tables herein: (a) Opioid (e.g., oxycodone base) (10.26%); Pharmaceutical sucrose acetate isobutyrate (SAIB) (36.21%); Triacetin, USP (26.82%); Isopropyl Myristate, NF (14.36%); cellulose acetate butyrate (CAB) CAB 381-20BP (4.94%); Hydroxyethyl Cellulose (5.38%); Colloidal Silicon Dioxide (2.02%); and Butylated Hydroxytoluene (0.02%); or (b) Opioid (e.g., oxycodone base) (10.26%); pharmaceutical sucrose acetate isobutyrate (SAIB) (36.46%); triacetin, USP (27.01%); Isopropyl Myristate, NF (14.36%); cellulose acetate butyrate (CAB) CAB 381-20BP (5.38%); Hydroxyethyl Cellulose (2.69%); Colloidal Silicon Dioxide (2.02%); gelucire 44/14, EP/NF (1.79%); and Butylated Hydroxytoluene (0.02%).
2. Apparatus is modified USP type II with a stationary basket with adjustable basket volume and testing medium was 0.1 N HCl with 0.6% SDS.

TABLE 2
% Cumulative Drug Release

| | 3 hr | 6 hr | 12 hr | 18 hr | 24 hr |
|---|---|---|---|---|---|
| 50 rpm | | | | | |
| 0.5% SDS | 19 | 37 | 70 | 88 | 97 |
| 0.75% SDS | 23 | 46 | 77 | 91 | 98 |
| 75 rpm | | | | | |
| 0.5% SDS | 26 | 43 | 71 | 87 | 96 |
| 0.75% SDS | 20 | 40 | 69 | 84 | 93 |
| 100 rpm | | | | | |
| 0.5% SDS | 32 | 53 | 79 | 92 | 99 |
| 0.75% SDS | 27 | 49 | 79 | 92 | 99 |

1. 40 mg capsule dosage form as described in Table 1.
2. Apparatus is modified USP type II with a stationary basket with adjustable basket volume and testing medium was 0.1 N HCl with SDS and rpm as indicated.

TABLE 3
% Cumulative Drug Release

| Vessel # | 0.5 hr | 1 hr | 2 hr | 3 hr | 6 hr | 12 hr | 18 hr | 24 hr |
|---|---|---|---|---|---|---|---|---|
| 1 | 8 | 14 | 21 | 28 | 42 | 65 | 81 | 92 |
| 2 | 8 | 14 | 22 | 28 | 43 | 66 | 82 | 93 |
| 3 | 9 | 15 | 25 | 32 | 49 | 72 | 84 | 92 |
| 4 | 8 | 15 | 25 | 33 | 53 | 78 | 92 | 99 |
| 5 | 9 | 15 | 25 | 33 | 51 | 76 | 89 | 97 |
| 6 | 9 | 14 | 22 | 28 | 42 | 64 | 80 | 92 |
| 7 | 7 | 13 | 21 | 28 | 44 | 68 | 85 | 96 |
| 8 | 7 | 12 | 21 | 28 | 44 | 69 | 84 | 92 |
| Average | 8 | 14 | 23 | 30 | 46 | 70 | 85 | 94 |
| % RSD | 9 | 8 | 8 | 8 | 9 | 7 | 5 | 3 |

1. 40 mg capsule dosage form as described in Table 1 with the exception that the oxycodone is micronized.
2. Apparatus is modified USP type II with a stationary basket with adjustable basket volume at 100 rpm and testing medium was 0.1 N HCl with 0.5% SDS.

TABLE 4
% Cumulative Drug Release

| | | | | |
|---|---|---|---|---|
| 3 hr | 6 hr | 12 hr | 18 hr | 24 hr |

% Cumulative Drug Release at 50 rpm

| | | | | | |
|---|---|---|---|---|---|
| 0% SDS | 22 | 34 | 51 | 64 | 73 |
| 0.2% SDS | 18 | 30 | 57 | 75 | 85 |
| 0.6% SDS | 16 | 33 | 65 | 82 | 92 |
| 1.0% SDS | 20 | 39 | 72 | 91 | 99 |

% Cumulative Drug Release at 125 rpm

| | | | | | |
|---|---|---|---|---|---|
| 0% SDS | 20 | 30 | 46 | 56 | 65 |
| 0.2% SDS | 28 | 42 | 63 | 76 | 84 |
| 0.6% SDS | 31 | 50 | 73 | 85 | 94 |
| 1.0% SDS | 27 | 40 | 76 | 91 | 99 |

% Cumulative Drug Release at 200 rpm

| | | | | | |
|---|---|---|---|---|---|
| 0% SDS | 21 | 30 | 44 | 54 | 62 |
| 0.2% SDS | 23 | 36 | 55 | 68 | 77 |
| 0.6% SDS | 29 | 48 | 73 | 86 | 94 |
| 1.0% SDS | 30 | 47 | 70 | 84 | 93 |

1. 40 mg capsule dosage form as described in Table 1 with the exception that the Oxycodone is micronized.
2. Apparatus is a standard USP type II apparatus and media is 0.N HCl with SDS and rpm as indicated.

TABLE 5
% Cumulative Drug Release at 50 rpm

| | 3 hr | 6 hr | 12 hr | 18 hr | 24 hr |
|---|---|---|---|---|---|
| Control (pH 6.8 | 16 | 20 | 23 | 27 | 30 |
| buffer) | | | | | |
| 10% ethanol | 42 | 51 | 59 | 64 | 67 |
| 20% Ethanol | 61 | 71 | 79 | 84 | 85 |
| 10% Propylene | 18 | 19 | 29 | 30 | 38 |
| glycol | | | | | |

1. 40 mg capsule dosage form as described in Table 1.
2. Apparatus is a standard USP type II apparatus and media is pH 6.8 buffer.

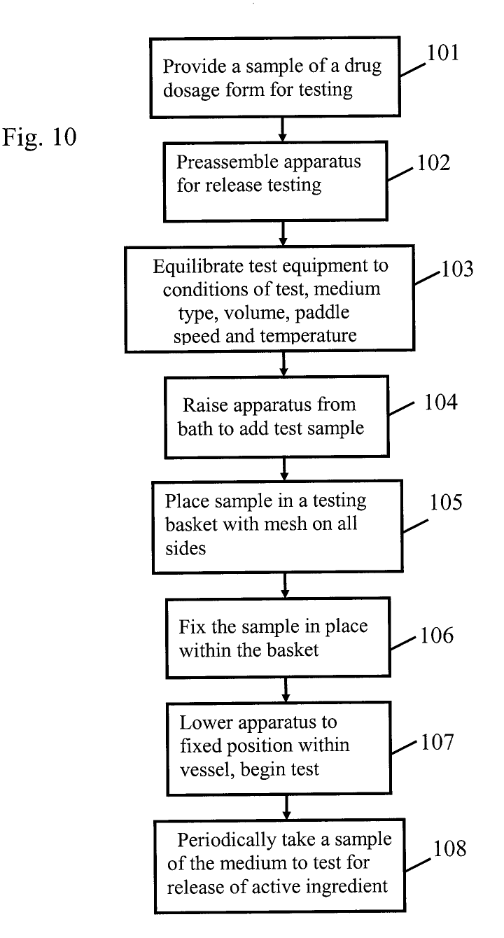

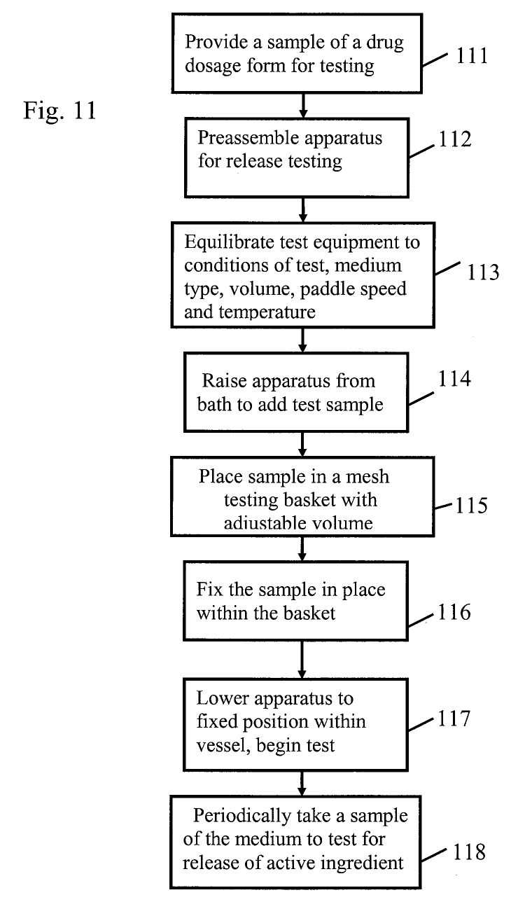

There are many ways to conduct testing using the vessel and apparatus described herein. Two of the methods are depicted in FIGS. 10 and 11. In the first method, depicted in FIG. 10, a user provides 101 a sample of a drug dosage form for testing. The equipment used in the test and described above is first pre-assembled 102 and then equilibrated 103 by lowering the vessel, paddle, and so forth to its desired position in the constant-temperature bath. The locations of the paddle and sample basket assembly are measured and affixed with careful control of their position in relation to each other and to the vessel. Such measurements are prescribed for consistent and repeatable set up of the apparatus between test runs. The vessel is filled with a testing medium, such as 0.1 N hydrochloric acid or other approved medium for dissolving the sample or for releasing a drug from the sample. The test equipment is then turned on, and the testing medium is agitated or stirred using a paddle or other stirrer. The temperature is monitored, the paddle shaft speed is check and monitored, and so forth. After equilibration, with all test components at the prescribed test temperature, the testing equipment is then raised 104 so that the test samples may be added.

The test sample is then placed 105 in a basket with mesh surrounding the sides of the test sample. The test sample may be affixed 106 with a particular position in the basket as described above, as with holders or wires. The apparatus, including the test article and test basket, is then lowered 107 in place to the same desired location (vertical) in which equilibration took place. The temperature of the test medium is controlled precisely, as is the paddle speed, so that dissolving or releasing rates may be determined in a reproducible manner. During testing, which may be conducted over a number of hours, a day or several days, samples are periodically taken 108 to measure dissolution or release (e.g., the release rate) of the drug from the test sample (e.g., dosage form). Other testing methods may be used, as noted above, with different solvents or media, and with different surfactants or release aids.

Another method for testing is depicted in FIG. 11. In this method, a user provides 111 a sample of a drug dosage form for testing. The equipment used in the test and described above is pre-assembled 112 and then equilibrated 113 by lowering the vessel, paddle, and so forth to its desired position in the constant-temperature bath. The vessel is filled with a testing medium, such as 0.1 N hydrochloric acid or other approved medium for dissolving the sample or for releasing a drug from the sample. A surfactant may be used and is preferably used for selected dosage forms used as test samples. The test equipment is then turned on, and the testing medium is agitated or stirred using a paddle or other stirrer. The temperature is monitored, the paddle shaft speed is check and monitored, and so forth. After equilibration, with all test components at the prescribed test temperature, the testing equipment is then raised 114 so that the test samples may be added.

The test sample is then placed 115 in a basket with mesh surrounding the sides of the test sample. The test sample may be affixed 116 with a particular position in the basket as described above, as with holders or wires. The apparatus, including the test sample and test basket, is then lowered 117 in place to the same desired location (vertical) in which equilibration took place. The temperature of the test medium is controlled precisely, as is the paddle speed, so that dissolving or extraction rates may be determined in a reproducible manner. During testing, which may be conducted over a number of hours, a day or several days, samples are periodically taken 118 to track dissolution or release of the drug from the test sample (e.g., dosage form). Other testing methods may be used, as noted above, with different solvents or media, and with different surfactants or release aids. For example, the basket or adjustable basket with the test sample may be mounted directly onto the paddle rather than on a separate sample holder.

### EMBODIMENTS

1. An apparatus for testing release from a drug sample, the apparatus comprising:

a generally cylindrical vessel, optionally having a lower portion of the vessel in a shape of a hemisphere;

a shaft and a paddle connected to the shaft suspended within the vessel, the shaft centered on the vessel; and

a sample holder mounted to or suspended within the vessel and a basket mounted to the sample holder, the basket suitable for holding the drug sample, wherein a volume of the basket is adjustable, and wherein the vessel is configured for circulating a medium within the vessel and around the drug sample.

2. The apparatus of embodiment 1, further comprising a standoff and a screen mesh mounted between the sample holder and the mesh basket.

3. The apparatus of embodiment 1, wherein the mesh basket is in the general shape of a cylinder, the basket mountable to the sample holder with an axis of the cylinder parallel to or perpendicular to a longitudinal axis of the sample holder.

4. The apparatus of embodiment 1, wherein the basket is suitable for mounting in an area of high flow of the vessel.

5. The apparatus of embodiment 1, wherein a volume of the basket is from about 150 to about 200 percent of a volume of the test sample.

6. The apparatus of embodiment 1, wherein a volume of the vessel is from about 100 ml to about 4000 ml, and optionally, so that a center of the shaft is within 2 mm of a central vertical axis of the vessel when the paddle is stationary and when the paddle is rotating, and wherein the paddle is separated by about 25 mm from a bottom of the vessel.

7. The apparatus of embodiment 1, further comprising an aqueous test medium having about 0.01 to about 1% wt percent surfactant.

8. The apparatus of embodiment 1, wherein the basket is in the general shape of the dosage form selected from the group consisting of an oval, a capsule, and a bullet.

9. The apparatus of embodiment 1, wherein the basket is mounted at an angle to a vertical or horizontal plane passing through the sample holder.

10. The apparatus of embodiment 1, further comprising at least one clip for securing the test sample to the basket.

11. An apparatus for testing release from a drug sample, the apparatus comprising:

a generally cylindrical vessel optionally having a lower portion of the vessel in a shape of a hemisphere;

a shaft and a paddle connected to the shaft suspended within the vessel, the shaft centered on the vessel; and

a sample holder mounted to the vessel or suspended within the vessel and a mesh basket mounted to the sample holder, the basket suitable for holding the drug sample, the mesh basket configured with mesh surrounding the sides of the drug sample.

12. The apparatus of embodiment 11, wherein a volume of the basket is adjustable and wherein the vessel is configured for circulating a medium within the vessel and around the test sample.

13. The apparatus of embodiment 11, wherein the mesh is from about 20 mesh, alternatively from about 10 mesh to about 40 mesh.

14. The apparatus of embodiment 11, wherein a distal portion of the sample holder is formed at an angle to an upper portion of the sample holder, or the test sample and the basket further comprise longitudinal orienting features, wherein the basket and the test sample are mounted at an angle other than a right angle to horizontal and vertical planes passing through the upper portion.

15. A method for testing release of a drug or an active pharmaceutical ingredient (API) from a sample from a dosage form used as a test sample, the method comprising:

suspending the sample in a mesh basket within a testing vessel, the testing vessel having a generally cylindrical shape and optionally a bottom in a shape of a hemisphere, and the mesh basket configured with mesh surrounding the sides of the sample;

placing a medium within the vessel;

rotating a paddle within the medium and around the sample; and

testing for release of the drug or API from the sample by periodically sampling the medium within the testing vessel.

16. The method of embodiment 15, wherein a release mechanism for the drug is dissolution, osmosis, or dissolution.

17. The method of embodiment 15, further comprising adding a surfactant to the medium.

18. The method of embodiment 15, wherein the paddle is rotated at about 100 rpm.

19. The method of embodiment 17, wherein the surfactant is selected from the group consisting of anionic and nonionic surfactants.

20. The method of embodiment 15, wherein the medium comprises 0.1 N hydrochloric acid and 0.5% sodium dodecyl sulfate.

21. The method of embodiment 15, wherein the test sample releases a majority of the drug by a diffusion mechanism.

22. The method of embodiment 15, further comprising orienting the mesh basket and the test sample at an angle to vertical and horizontal planes passing through the vessel.

23. A method for testing release of a drug or active pharmaceutical ingredient (API) from a dosage form used as a test sample, the method comprising:

suspending the test sample in a mesh basket within a testing vessel, the testing vessel having a generally cylindrical shape and optionally a bottom in a shape of a hemisphere, wherein a volume of the mesh basket is adjustable and is configured with mesh surrounding the side of the test sample;

placing a medium within the vessel;

rotating a shaft and a paddle within the medium and around the sample; and

testing for release of the drug or API from the sample by periodically sampling the medium within the testing vessel.

24. The method of embodiment 23, wherein the drug sample releases the active ingredient by a mechanism selected from the group consisting of diffusion and osmosis.

25. The method of embodiment 23, further comprising placing the drug sample in a high-flow zone of the testing vessel.

26. The method of embodiment 23, wherein the medium comprises from about 0.1% to about 1% of a surfactant.

27. The method of embodiment 26, wherein the surfactant comprises a nonionic or anionic surfactant having an HLB value of at least about 10.

28. The method of embodiment 23, wherein the drug is in a dosage form intended for administration as an injectable depot, an implant, oral, sublingual, transdermal, suppository, or topical.

29. The method of embodiment 23, wherein the test sample is fixedly held within the mesh basket during testing.

30. The method of embodiment 23, further comprising orienting the mesh basket the test sample at an angle to vertical and horizontal planes passing through the vessel.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims. All reference, to patents, and patent applications referred to in the application are herein incorporated by reference in their entirety.

What is claimed is:

1. An apparatus for testing release from a drug sample, the apparatus comprising:
a generally cylindrical vessel, optionally having a lower portion of the vessel in a shape of a hemisphere;
a shaft and a paddle connected to the shaft suspended within the vessel, the shaft centered on the vessel; and
a sample holder mounted to or suspended within the vessel and a basket mounted to the sample holder, the basket suitable for holding the drug sample, wherein a volume of the basket is adjustable, and wherein the vessel is configured for circulating a medium within the vessel and around the drug sample.

2. The apparatus of claim 1, further comprising a standoff and a screen mesh mounted between the sample holder and the mesh basket.

3. The apparatus of claim 1, wherein the mesh basket is in the general shape of a cylinder, the basket mountable to the sample holder with an axis of the cylinder parallel to or perpendicular to a longitudinal axis of the sample holder.

4. The apparatus of claim 1, wherein the basket is suitable for mounting in an area of high flow of the vessel.

5. The apparatus of claim 1, wherein a volume of the basket is from about 150 to about 200 percent of a volume of the test sample.

6. The apparatus of claim 1, wherein a volume of the vessel is from about 100 ml to about 4000 ml, and optionally, so that a center of the shaft is within 2 mm of a central vertical axis of the vessel when the paddle is stationary and when the paddle is rotating, and wherein the paddle is separated by about 25 mm from a bottom of the vessel.

7. The apparatus of claim 1, further comprising an aqueous test medium having about 0.01 to about 1% wt percent surfactant.

8. The apparatus of claim 1, wherein the basket is in the general shape of the dosage form selected from the group consisting of an oval, a capsule, and a bullet.

9. The apparatus of claim 1, wherein the basket is mounted at an angle to a vertical or horizontal plane passing through the sample holder.

10. The apparatus of claim 1, further comprising at least one clip for securing the test sample to the basket.

11. An apparatus for testing release from a drug sample, the apparatus comprising:
a generally cylindrical vessel optionally having a lower portion of the vessel in a shape of a hemisphere;
a shaft and a paddle connected to the shaft suspended within the vessel, the shaft centered on the vessel; and
a sample holder mounted to the vessel or suspended within the vessel and a mesh basket mounted to the sample holder, the basket suitable for holding the drug sample, the mesh basket configured with mesh surrounding the sides of the drug sample.

12. The apparatus of claim 11, wherein a volume of the basket is adjustable and wherein the vessel is configured for circulating a medium within the vessel and around the test sample.

13. The apparatus of claim 11, wherein the mesh is from about 20 mesh, alternatively from about 10 mesh to about 40 mesh.

14. The apparatus of claim 11, wherein a distal portion of the sample holder is formed at an angle to an upper portion of the sample holder, or the test sample and the basket further comprise longitudinal orienting features, wherein the basket and the test sample are mounted at an angle other than a right angle to horizontal and vertical planes passing through the upper portion.

15. A method for testing release of a drug or an active pharmaceutical ingredient (API) from a sample, the method comprising:
suspending the sample in a mesh basket within a testing vessel, the testing vessel having a generally cylindrical shape and optionally a bottom in a shape of a hemisphere, and the mesh basket configured with mesh surrounding the sides of the sample;
placing a medium within the vessel;
rotating a paddle within the medium and around the sample; and
testing for release of the drug or API from the sample by periodically sampling the medium within the testing vessel.

16. The method of claim 15, wherein a release mechanism for the drug is dissolution, osmosis, or dissolution.

17. The method of claim 15, further comprising adding a surfactant to the medium.

18. The method of claim 15, wherein the paddle is rotated at about 100 rpm.

19. The method of claim 17, wherein the surfactant is selected from the group consisting of anionic and nonionic surfactants.

20. The method of claim 15, wherein the medium comprises 0.1 N hydrochloric acid and 0.5% sodium dodecyl sulfate.

21. The method of claim 15, wherein the test sample releases a majority of the drug by a diffusion mechanism.

22. The method of claim 15, further comprising orienting the mesh basket and the test sample at an angle to vertical and horizontal planes passing through the vessel.

23. The method of claim 15, wherein the release testing predicts or models in vivo behavior of the drug or API.

24. The method of claim 15, wherein the release testing is used to establish an in vitro-in vivo correlation (IVIVC).

25. The method of claim 15, wherein the last sampling time of periodically sampling is the time point that is the end of a dosing period established for the drug or API.

26. The method of claim 15, wherein the last sampling time of periodically sampling is the time point where 80% dissolution occurs.

27. A method for testing release of a drug or active pharmaceutical ingredient (API), the method comprising:
suspending the test sample in a mesh basket within a testing vessel, the testing vessel having a generally cylindrical shape and optionally a bottom in a shape of a hemisphere, wherein a volume of the mesh basket is adjustable and is configured with mesh surrounding the side of the test sample;
placing a medium within the vessel;
rotating a shaft and a paddle within the medium and around the sample; and
testing for release of the drug or API from the sample by periodically sampling the medium within the testing vessel.

28. The method of claim 27, wherein the drug sample releases the active ingredient by a mechanism selected from the group consisting of diffusion and osmosis.

29. The method of claim 27, further comprising placing the drug sample in a high-flow zone of the testing vessel.

30. The method of claim 27, wherein the medium comprises from about 0.1% to about 1% of a surfactant.

31. The method of claim 30, wherein the surfactant comprises a nonionic or anionic surfactant having an HLB value of at least about 10.

32. The method of claim 27, wherein the drug is in a dosage form intended for administration as an injectable depot, an implant, oral, sublingual, transdermal, suppository, or topical.

33. The method of claim 27, wherein the test sample is fixedly held within the mesh basket during testing.

34. The method of claim 27, further comprising orienting the mesh basket and the test sample at an angle to vertical and horizontal planes passing through the vessel.

35. The method of claim 27, wherein the release testing predicts or models in vivo behavior of the drug or API.

36. The method of claim 27, wherein the release testing is used to establish an in vitro-in vivo correlation (IVIVC).

37. The method of claim 27, wherein the last sampling time of periodically sampling is the time point that is the end of a dosing period established for the drug or API.

38. The method of claim 27, wherein the last sampling time of periodically sampling is the time point where 80% dissolution occurs.

39. A method for testing release of a drug or an active pharmaceutical ingredient (API), the method comprising:
suspending the drug in a mesh basket on a paddle within a testing vessel, the testing vessel having a generally cylindrical shape and optionally a bottom in a shape of a hemisphere, wherein a volume of the mesh basket is adjustable and is configured with mesh surrounding a side of the test sample;
placing a medium within the vessel;
rotating a shaft and the paddle within the medium; and
testing for release of the drug or API by periodically sampling the medium within the testing vessel.
